(19) United States
(12) Patent Application Publication
(10) Pub. No.: US 2023/0283558 A1
(43) Pub. Date: Sep. 7, 2023

(54) Bit Index Explicit Replication Traffic Engineering Fast Reroute

(71) Applicant: HUWAEI TECHNOLOGIES CO., LTD., Shenzhen, Guangdong Province (CN)

(72) Inventor: Huaimo Chen, Bolton, MA (US)

(21) Appl. No.: 18/318,331

(22) Filed: May 16, 2023

Related U.S. Application Data
(63) Continuation of application No. PCT/US2021/061428, filed on Dec. 1, 2021.
(60) Provisional application No. 63/128,567, filed on Dec. 21, 2020.

(51) Int. Cl. H04L 47/125; H04L 45/16; H04L 45/28; H04L 47/122

(52) U.S. Cl. CPC H04L 47/125; H04L 45/16; H04L 45/28; H04L 47/122

(57) ABSTRACT

A method implemented by a network node in a Bit Index Explicit Replication Traffic Engineering (BIER-TE) domain is disclosed. The method includes generating a fast reroute bit index forwarding table (FRR-BIFT) containing a backup path having one or more bit positions from the network node to each next hop of a neighbor node of the network node, and sending a packet to the next hop of the neighbor node in accordance with the one or more bit positions in the backup path of the FRR-BIFT when the neighbor node has failed.

### CROSS-REFERENCE TO RELATED APPLICATIONS

This patent application is a continuation of International Application No. PCT/US2021/061428 filed on Dec. 1, 2021, by Futurewei Technologies, Inc., and titled “Bit Index Explicit Replication Traffic Engineering Fast Reroute,” which claims the benefit of U.S. Provisional Patent Application No. 63/128,567 filed Dec. 21, 2020 by Huaimo Chen and titled “BIER-TE Fast Reroute,” which is hereby incorporated by reference.

### TECHNICAL FIELD

The present disclosure is generally related to the field of fast re-route (FRR) protection and, in particular, to FRR protection against the failure of a node in a Bit Index Explicit Replication-Traffic Engineering (BIER-TE) domain.

### BACKGROUND

BIER mechanisms provide optimized forwarding of multicast data packets through a BIER domain. BIER domains may not require the use of a protocol for explicitly building multicast distribution trees. Further, BIER domains may not require intermediate nodes to maintain any per-flow state. BIER is described in further detail in Internet Engineering Task Force (IETF) document Request for Comments (RFC) 8279 entitled “Multicast Using Bit Index Explicit Replication (BIER)” by IJ. Wijnands, et al., published November 2017.

Traffic Engineering (TE) is the process of steering traffic across to a telecommunications network to facilitate efficient use of available bandwidth between a pair of routers. Bit Index Explicit Replication (BIER) Traffic/Tree Engineering (BIER-TE) is described in IETF document “Tree Engineering for Bit Index Explicit Replication (BIER-TE)” by T. Eckert, et al., published Jul. 9, 2021.

### SUMMARY

The disclosed aspects/embodiments provide a fast reroute procedure for a BIER-TE domain. To facilitate the fast reroute procedure, a network node generates a fast reroute bit index forwarding table (FRR-BIFT) containing a backup path having one or more bit positions used to reach each next hop of a neighbor node of the network node. The network node sends a packet to the next hop of the neighbor node in accordance with the one or more bit positions in the backup path of the FRR-BIFT when the neighbor node has failed. Therefore, packet routing within the BIER-TE domain is improved.

A first aspect relates to a method implemented by a network node in a Bit Index Explicit Replication Traffic Engineering (BIER-TE) domain, comprising: generating a fast reroute bit index forwarding table (FRR-BIFT) containing a backup path from the network node to each next hop of a neighbor node of the network node, wherein the backup path is represented by one or more bit positions for adjacencies along the backup path; and sending a packet to the next hop of the neighbor node in accordance with the one or more bit positions in the backup path of the FRR-BIFT when the neighbor node has failed.

Optionally, in any of the preceding aspects, another implementation of the aspect provides sending the packet to the neighbor node in accordance with the FRR-BIFT when the neighbor node is operating normally.

Optionally, in any of the preceding aspects, another implementation of the aspect provides replacing one or more bit positions in a point to multipoint (P2MP) path in the packet with one or more bit positions of the backup path prior to sending the packet to the next hop of the neighbor node.

Optionally, in any of the preceding aspects, another implementation of the aspect provides setting an entry in a backup entry active (BEA) field of the FRR-BIFT to a first value when the neighbor node is operating normally, and setting the entry in a backup entry active (BEA) field of the FRR-BIFT to a second value when the neighbor node has failed.

Optionally, in any of the preceding aspects, another implementation of the aspect provides that the first value is zero and the second value is one.

Optionally, in any of the preceding aspects, another implementation of the aspect provides clearing the bit position of a bit-forwarding egress router (BFER) in the packet prior to sending the packet to the next hop when the BFER is on the backup path to the next hop but not on any path branch of a point-to-multipoint (P2MP) path in the packet from the network node.

Optionally, in any of the preceding aspects, another implementation of the aspect provides that the FRR-BIFT is generated by the network node prior to receiving the packet.

Optionally, in any of the preceding aspects, another implementation of the aspect provides detecting a failure of the neighbor node, and wherein the FRR-BIFT is generated by the network node prior to detecting the failure.

Optionally, in any of the preceding aspects, another implementation of the aspect provides sending the packet to the next hop of the neighbor node comprises clearing a bit position for an adjacency from the neighbor node to the next hop on a point-to-multipoint (P2MP) path in the packet and adding the one or more bit positions in the backup path from the network node to the next hop into the packet when the next hop is on the P2MP path prior to sending the packet to the next hop.

A second aspect relates to network node in a Bit Index Explicit Replication Traffic Engineering (BIER-TE) domain, comprising: a memory storing instructions; and one or more processors coupled to the memory, wherein the one or more processors are configured to execute the instructions to cause the network node to: generate a fast reroute bit index forwarding table (FRR-BIFT) containing a backup path from the network node to each next hop of a neighbor node of the network node, wherein the backup path is represented by one or more bit positions for adjacencies along the backup path; and send a packet to the next hop of the neighbor node in accordance with the one or more bit positions in the backup path of the FRR-BIFT when the neighbor node has failed.

Optionally, in any of the preceding aspects, another implementation of the aspect provides that the one or more processors are configured to send the packet to the neighbor node in accordance with the FRR-BIFT when the neighbor node is operating normally.

Optionally, in any of the preceding aspects, another implementation of the aspect provides that the FRR-BIFT includes a backup entry active (BEA) field, and wherein an entry in the BEA field is set to indicate whether the neighbor node is working or has failed.

Optionally, in any of the preceding aspects, another implementation of the aspect provides that the one or more processors are configured to set an entry in a backup entry active (BEA) field of the FRR-BIFT to a first value when the neighbor node is operating normally, and to set the entry in a backup entry active (BEA) field of the FRR-BIFT to a second value when the neighbor node has failed.

Optionally, in any of the preceding aspects, another implementation of the aspect provides that the first value is zero and the second value is one.

Optionally, in any of the preceding aspects, another implementation of the aspect provides clearing the bit position of a bit-forwarding egress router (BFER) in the packet prior to sending the packet to the next hop when the BFER is on the backup path to the next hop but not on any path branch of a point-to-multipoint (P2MP) path in the packet from the network node.

Optionally, in any of the preceding aspects, another implementation of the aspect provides the FRR-BIFT is generated by the network node prior to receiving the packet.

Optionally, in any of the preceding aspects, another implementation of the aspect provides that the one or more processors are configured to detect a failure of the neighbor node, and wherein the FRR-BIFT is generated by the network node prior to detecting the failure.

Optionally, in any of the preceding aspects, another implementation of the aspect provides sending the packet to the next hop of the neighbor node comprises clearing a bit position for an adjacency from the neighbor node to the next hop on a point-to-multipoint (P2MP) path in the packet and adding the one or more bit positions in the backup path from the network node to the next hop into the packet when the next hop is on the P2MP path prior to sending the packet to the next hop.

A third aspect relates to network node in a Bit Index Explicit Replication Traffic Engineering (BIER-TE) domain, comprising: generating means configured to generate a fast reroute bit index forwarding table (FRR-BIFT) containing a backup path from the network node to each next hop of a neighbor node of the network node, wherein the backup path is represented by one or more bit positions for adjacencies along the backup path; and sending means configured to send a packet to the next hop of the neighbor node in accordance with the one or more bit positions in the backup path of the FRR-BIFT when the neighbor node has failed.

For the purpose of clarity, any one of the foregoing embodiments may be combined with any one or more of the other foregoing embodiments to create a new embodiment within the scope of the present disclosure.

These and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a schematic diagram of a BIER-TE topology including a BIER-TE domain.

FIG. 2 is a schematic diagram of a fast reroute bit index forwarding table (FRR-BIFT) of a network node according to an embodiment of the disclosure.

FIG. 3 is an algorithm used to implement a portion of the forwarding procedure using the FRR-BIFT according to an embodiment of the disclosure.

FIG. 4 is an algorithm used to implement a portion of the forwarding procedure using the FRR-BIFT according to an embodiment of the disclosure.

FIG. 5 is a method implemented by a network node in the BIER-TE domain according to an embodiment of the disclosure.

FIG. 6 is a schematic diagram of a network apparatus according to an embodiment of the disclosure.

### DETAILED DESCRIPTION

It should be understood at the outset that although an illustrative implementation of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

Existing solutions for BIER-TE FRR have drawbacks. One solution is point-to-point (PTT) tunneling. In PTT, a BIER-TE packet is rerouted by a point of local repair (PLR) around the failure to a next hop (NH) and neighbor NHs through unicast tunnels. Next hop is a routing term that refers to the next closest network node (e.g., router) a packet can go through. Thus, PTT depends on tunnels. However, the tunnels may increase the operation expense (Opex). Another solution is BIET-in-BIER encapsulation (BBE). In BBE, a BIER-TE packet is rerouted by the PLR to a NH and neighbor NHs by encapsulating the packet in another BIER-TE header. However, the additional BIER-TE header increases overhead. A further solution is header modification (HM). In HM, a backup path is added into the existing BIER-TE header by using AddBitMask and a ResetBitmask functions. However, this procedure may result in duplicate packets being received at some destinations.

Disclosed herein is a fast reroute procedure for a BIER-TE domain. To facilitate the fast reroute procedure, a network node generates a fast reroute bit index forwarding table (FRR-BIFT) containing a backup path having one or more bit positions used to reach each next hop of a neighbor node of the network node. The network node sends (e.g., forwards) a packet to the next hop of the neighbor node in accordance with the one or more bit positions in the backup path of the FRR-BIFT when the neighbor node has failed. Therefore, packet routing within the BIER-TE domain is improved.

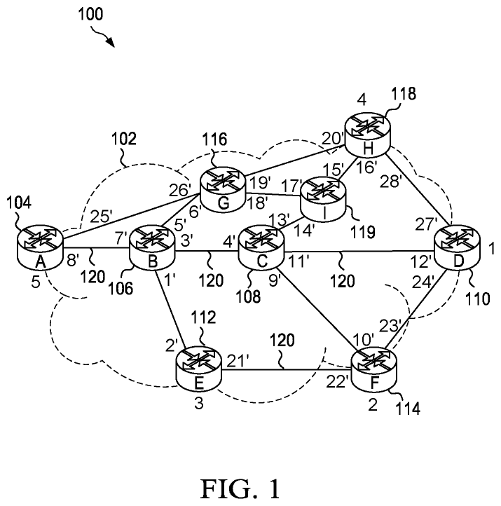

FIG. 1 is a schematic diagram of a BIER-TE topology 100 including a BIER-TE domain 102. The BIER-TE domain 102 may be part of a larger BIER-TE domain (not shown). As such, the BIER-TE domain 102 may be referred to herein as a BIER-TE sub-domain. The BIER-TE domain 102 comprises a plurality of network nodes 104, 106, 108, 110, 112, 114, 116, 118, and 119. While nine network nodes 104-119 are shown in the BIER-TE domain 102, more or fewer nodes may be included in practical applications.

For ease of discussion, all of the network nodes 104-119 have been given a letter designation. For example, the network node 104 has the designation A, the network node 106 has the designation B, the network node 108 has the designation C, the network node 110 has the designation D, the network node 112 has the designation E, the network node 114 has the designation F, the network node 116 has the designation G, the network node 118 has the designation H, and the network node 119 has the designation I.

Each of the network nodes 104-119 is a bit forwarding router (BFR). Some of the network nodes, namely the network nodes 104, 110, 112, 114 and 118, are disposed at an edge of the BIER-TE domain 102. The network nodes 104, 110, 112, 114 and 118 receiving multicast packets from outside the BIER-TE domain 102 may be referred to as an ingress BFR (BFIR). The network nodes 104, 110, 112, 114 and 118 transmitting multicast packets out of the BIER-TE domain 102 may be referred to as an egress BFR (BFER). Depending on the direction of multicast packet traffic, each of the network nodes 104-118 may function as a BFIR or a BFER.

As shown in FIG. 1, the bit position (BP) for forward connected (fw-con) adjacency between the various network nodes 104-119 is identified. In the illustrated example, the BP for a fw-con adjacency indicates how to reach an adjacent node and is represented as i′, where i is an integer corresponding to one of the forward connected adjacencies between the network nodes 104-119 in the BIER-TE domain 102. In the illustrated embodiment of FIG. 1, there are twenty-eight total BPs for twenty-eight fw-con adjacencies. However, there may be more or fewer BPs for fw-con adjacencies in other BIER-TE domains in practical applications.

As an example of how the BPs for fw-con adjacencies operate with regard to FIG. 1, 7′ is the BP for the fw-con adjacency from node 104 to node 106, and 8′ is the BP for the fw-con adjacency from node 106 to node 104. 7′ is configured on the link from node 104 to node 106 and advertised to all the network nodes in the network. 8′ is configured on the link from node 106 to node 104 and advertised to all the network nodes in the network. As another example, 12′ is the BP for the fw-con adjacency from node 108 to node 110, and 11′ is the BP for the fw-con adjacency from node 110 to node 108. 12′ is configured on the link from node 108 to node 110 and advertised to all the network nodes in the network. 11′ is configured on the link from node 110 to node 108 and advertised to all the network nodes in the network. Similarly, 14′ is the BP for the fw-con adjacency from node 108 to node 119, and 13′ is the BP for the fw-con adjacency from node 119 to node 108. 14′ is configured on the link from node 108 to node 119 and advertised to all the network nodes in the network. 13′ is configured on the link from node 119 to node 108 and advertised to all the network nodes in the network. The other BPs for fw-con adjacencies may be determined in a similar fashion as represented by the various values for i′ on FIG. 1. For ease of discussion, each BP for a fw-con adjacency may be simply referred to herein as the BP, the adjacency, or the BP for the adjacency.

Each of the network nodes 104, 110, 112, 114, and 118 may be referred to herein as a destination network node or egress BFR (BFER). The network nodes 104, 110, 112, 114 and 118 have each been assigned a BP, a set index (SI), and a BitString. The BP of a BFER is called a local decapsulation (decap) adjacency or local decap BP. In the illustrated example, the BP of a BFER is represented as j, where j is an integer corresponding to one of the local decap adjacencies in the BIER-TE domain 102. In the illustrated embodiment of FIG. 1, there are five local decap adjacencies for five network nodes 104, 110, 112, 114 and 118 operating as BFERs. As an example, the BPs of network nodes 104, 110, 112, 114 and 118 are 5, 1, 3, 2 and 4, respectively. For simplicity, these BPs for local decap adjacencies are represented by (SI:BitString), where SI=0 and BitString is of 8 bits. BPs 1, 2, 3, 4, and 5 are collectively represented by 1 (0:00000001), 2 (0:00000010), 3 (0:00000100), 4 (0:00001000) and 5 (0:00010000), respectively. The BP of a BFER is advertised by the BFER to all the network nodes in the network.

In an embodiment, the BPs for fw-con adjacencies are represented by (SI:BitString), where SI>=6 and BitString is of 8 bits. For example, the BP of 2′ has a SI of 6, and has a BitString of 00000010 (collectively represented by 2′ (6:00000010)). The BP of 4′ has a SI of 6, and has a BitString of 00001000 (collectively represented by 4′ (6:00001000)). The BP of 6′ has a SI of 6, and has a BitString of 00100000 (collectively represented by 6′ (6:00100000)). The BP of 8′ has a SI of 6, and has a BitString of 10000000 (collectively represented by 8′ (6:10000000)). In this way, the BP is represented by a number that indicates which bit is set in the BitString.

Each of the network nodes 104-119 has one or more neighbor nodes. As used herein, a neighbor node refers to a network node that is only one hop away from the network node. For example, network node 106 has four neighbor nodes in FIG. 1, namely network node 104, network node 108, network node 112, and network node 116. Indeed, each of network node 104, network node 108, network node 112, and network node 116 are only one hop away from network node 106.

The network nodes 104-119 in FIG. 1 are coupled to, and communicate with each other, via links 120. The links 120 may be wired, wireless, or some combination thereof. Each of the links 120 may have a cost. The cost of each of the links 120 may be the same or different, depending on the BIER-TE network and conditions therein.

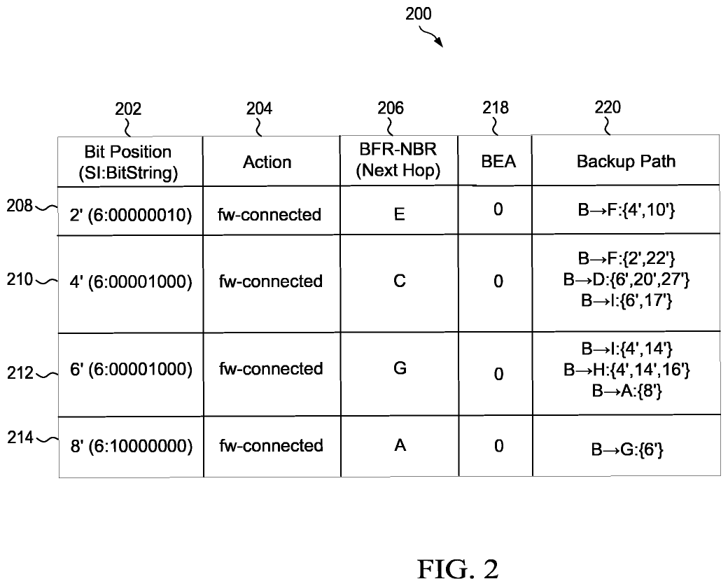

FIG. 2 is a schematic diagram of fast reroute bit index forwarding table (FRR-BIFT) 200 of a network node. Each of the network nodes 104-119 in the BIER-TE topology 100 in FIG. 1 generates an FRR-BIFT 200. In an embodiment, the FRR-BIFT is generated based on a bit index routing table (BIRT) or a bit index forwarding table (BIFT) (not shown) that the network nodes 104-119 built.

The FRR-BIFT 200 depicted in FIG. 2 is the FRR-BIFT 200 built on the network node 106 in FIG. 1. As shown, the FRR-BIFT 200 includes five columns of information. The first column 202 includes the BP, SI, and BitString of each adjacency directly coupled to the network node 106 in the BIER-TE topology 100. The adjacency in column 202 may be a forward connected adjacency to a destination network node (e.g., network node 112 or network node 104) from network node 106 or a forward connected adjacency to a neighbor network node (e.g., network node 108 or network node 116) from network node 106. A second column 204 indicates the action to be taken by the network node 106, which in the illustrated example is a forward connected adjacency. A third column 206 identifies the neighbor node (BFR-NBR) of the network node 106 used to reach the adjacent network node identified by the adjacency in the first column 202, which is why the neighbor node in the third column 206 may also be referred to as the next hop of the network node 106. The first column 202, the second column 204, and the third column 206 in the FRR-BIFT 200 may be utilized by the network node 106 during normal operations (i.e., when the network node identified in column 206 is operating normally). That is, these columns are used when the entry in the backup entry active (BEA) field is set to zero.

The fourth column 218 includes a backup entry active (BEA) field. An entry in the BEA field is set to indicate whether the network node identified in column 206 (i.e., the BFR-NBR or next hop) is working or has failed. As an example, when an entry in the BEA field is set to a value of zero the network node identified in column 206 is properly functioning. However, when an entry in the BEA field is set to a value of one the network node identified in column 206 is not properly functioning (i.e., has failed). The fourth column 218 and the fifth column 220 in the FRR-BIFT 200 may be utilized by the network node 106 during abnormal operations (i.e., when the network node identified in column 206 is not operating normally or has failed). That is, these columns are used when the entry in the BEA field is set to one.

The fifth column 220 includes a backup path field. An entry in the backup path field identifies a backup path used to reach each next hop of a neighbor node of the network node when the neighbor node is operating abnormally or has failed. As shown in FIG. 2, the backup path may include one or more BPs (e.g., 4′, 10′) in an ordered set. As an example, the backup path field in the first row 208 of the FRR-BIFT 200 includes the expression B∴F:{4′, 10′}. This expression indicates that the backup path from network node 106 (a.k.a., network node B) to network node 114 (a.k.a., network node F), which is the next hop of network node 112 (a.k.a., network node E) identified in the third column 206, is along forward connected adjacency 4′ (i.e., the BP of the forward connected adjacency from network node 106 to the network node 108) and then 10′ (i.e., the BP of the forward connected adjacency from network node 108 to the network node 114).

The backup path field in the second row 210 of the FRR-BIFT 200 identifies a backup path to each of the next hops of network node 108 (a.k.a., network node C) without going through node 108. The first backup path includes the expression B∴F:{2′, 22′}. This expression indicates that the backup path from network node 106 to network node 114, which is the next hop of network node 108 (a.k.a., network node C) identified in the third column 206, is along forward connected adjacency 2′ (i.e., the BP of the forward connected adjacency from network node 106 to the network node 112) and then 22′ (i.e., the BP of the forward connected adjacency from network node 112 to the network node 114).

The second backup path includes the expression B∴D:{6′, 20′, 27′}. This expression indicates that the backup path from network node 106 to network node 110 is along forward connected adjacency 6′ (i.e., the BP of the forward connected adjacency from network node 106 to the network node 116), then 20′ (i.e., the BP of the forward connected adjacency from network node 116 to the network node 118), and then 27′ (i.e., the BP of the forward connected adjacency from network node 118 to the network node 110). The third backup path includes the expression B∴I:{6′, 17′}. This expression indicates that the backup path from network node 106 to network node 119 is along forward connected adjacency 6′ (i.e., the BP of the forward connected adjacency from network node 106 to the network node 116) and then 17′ (i.e., the BP of the forward connected adjacency from network node 116 to the network node 119).

The backup path field in the third row 212 of the FRR-BIFT 200 identifies a backup path to each of the next hops of network node 116 (a.k.a., network node G) without going through node G. The first backup path includes the expression B∴I:{4′, 14′}. This expression indicates that the backup path from network node 106 to network node 119, which is the next hop of network node 116 (a.k.a., network node G) identified in the third column 206, is along forward connected adjacency 4′ (i.e., the BP of the forward connected adjacency from network node 106 to the network node 108) and then 14′ (i.e., the BP of the forward connected adjacency from network node 108 to the network node 119).

The second backup path includes the expression B∴H:{4′, 14′, 16′}. This expression indicates that the backup path from network node 106 to network node 118 is along forward connected adjacency 4′ (i.e., the BP of the forward connected adjacency from network node 106 to the network node 108), then 14′ (i.e., the BP of the forward connected adjacency from network node 108 to the network node 119), and then 16′ (i.e., the BP of the forward connected adjacency from network node 119 to the network node 118). The third backup path includes the expression B∴A:{8′}. This expression indicates that the backup path from network node 106 to network node 104 is along forward connected adjacency 8′ (i.e., the BP of the forward connected adjacency from network node 106 to the network node 104).

The backup path field in the fourth row 214 of the FRR-BIFT 200 identifies a backup path to each of the next hops of network node 104 (a.k.a., network node A) without going through node 104. The first backup path includes the expression B∴G:{6′}. This expression indicates that the backup path from network node 106 to network node 116, which is the next hop of network node 104 (a.k.a., network node A) identified in the in the third column 206, is along forward connected adjacency 6′ (i.e., the BP of the forward connected adjacency from network node 106 to the network node 116).

Keeping the above in mind and referring back to FIG. 1, an example of how packets are routed during normal operations and how packets are routed during a failure is provided. During normal operations, when a packet is received at network node 104, the network node 104 adds or encapsulates a point to multipoint (P2MP) path into the packet. For example, the network node 104 adds the P2MP path from node A to nodes D and H {26′, 20′, 7′, 4′, 12′, 4, 1} into the received packet. Thereafter, the network node 104 removes its adjacencies 26′ and 7′ from the packet, makes a first copy of the packet, and transmits the first copy of the packet to network node 116 using adjacency 26′ (i.e., the forwarding entry for the forward connected adjacency 26′ in the FRR-BIFT built on the network node 104). The network node 104 also makes a second copy of the packet, removes its adjacencies 26′ and 7′ from the second copy, and sends the second copy to network node 106 using adjacency 7′ (i.e., the forwarding entry for the forward connected adjacency 7′ in the FRR-BIFT built on the network node 104).

The network node 116 receives the packet, which now contains the path {20′, 4′, 12′, 4, 1}. The network node 116 removes its adjacency 20′ from the packet and transmits the packet to network node 118 using adjacency 20′ (i.e., the forwarding entry for the forward connected adjacency 20′ in the FRR-BIFT built on the network node 116). The network node 118 receives the packet, which now contains the path {4′, 12′, 4, 1}. The network node 118 decapsulates the packet with BP=4 for BFER H (i.e., egress node 118) and transmits the payload of the packet to the multicast overlay.

The network node 106 receives the packet, which contains the path {20′, 4′, 12′, 4, 1}. The network node 106 removes its adjacency 4′ from the packet and transmits the packet to network node 108 using adjacency 4′ (i.e., the forwarding entry for the forward connected adjacency 4′ in the FRR-BIFT built on the network node 106). The network node 108 receives the packet, which contains the path {20′, 12′, 4, 1}. The network node 108 removes its adjacency 12′ from the packet and transmits the packet to network node 110 using adjacency 12′ (i.e., the forwarding entry for the forward connected adjacency 12′ in the FRR-BIFT built on the network node 108). The network node 110 receives the packet, which now contains the path {20′, 4, 1}. The network node 118 decapsulates the packet with BP=1 for BFER D (i.e., egress node 110) and transmits the payload of the packet to the multicast overlay.

During abnormal operations (e.g., network node 108 has failed), when a packet is received at network node 104, the network node 104 adds or encapsulates a point to multipoint (P2MP) path into the packet. For example, the network node 104 adds the path from node A to nodes D and H {26′, 20′, 7′, 4′, 12′, 4, 1} into the received packet. Thereafter, the network node 104 removes its adjacencies 26′ and 7′ from the packet, makes a first copy of the packet, and transmits the first copy of the packet to network node 116 using adjacency 26′. The network node 104 also makes a second copy of the packet, removes its adjacencies 26′ and 7′ from the second copy, and sends the second copy to network node 106 using adjacency 7′.

The network node 116 receives the packet, which now contains the path {20′, 4′, 12′, 4, 1}. The network node 116 removes its adjacency 20′ from the packet and transmits the packet to network node 118 using adjacency 20′. The network node 118 receives the packet, which now contains the path {4′, 12′, 4, 1}. The network node 118 decapsulates the packet with BP=4 and transmits the payload of the packet to the multicast overlay.

The network node 106 receives the packet, which contains the path {20′, 4′, 12′, 4, 1}. The network node 106 removes its adjacency 4′ from the packet. Since network node 108, which is a neighbor node of the network node 106, has failed, the network node 106 removes BP 12′ for the forward connected adjacency from the failed node 108 to the network node 110 that is a next hop of the failed node 108 and is on the path in the packet, removes the BP 4 (i.e., the local decap adjacency of BFER H) from the path of the packet that is on the backup path because BFER H is not on a path branch of the path in the packet from network node 106, and adds the BPs for the backup path from network node 106 to network node 110. The added BPs are {6′, 20′, 27′}. Thus, the packet now contains the path {6′, 20′, 27′, 1}. Thereafter, network node 106 removes its adjacency 6′ from the packet and transmits the packet to network node 116 using adjacency 6′.

The network node 116 receives the packet, which contains the path {20′, 27′, 1}. The network node 116 removes its adjacency 20′ from the packet and transmits the packet to network node 118 using adjacency 20′. The network node 118 receives the packet, which now contains the path {27′, 1}. The network node 118 removes its adjacency 27′ from the packet and transmits the packet to network node 110 using adjacency 27′. The network node 110 receives the packet, which now contains the path {1}. The network node 110 decapsulates the packet with BP=1 for BFER D (i.e., egress node 110) and transmits the payload of the packet to the multicast overlay.

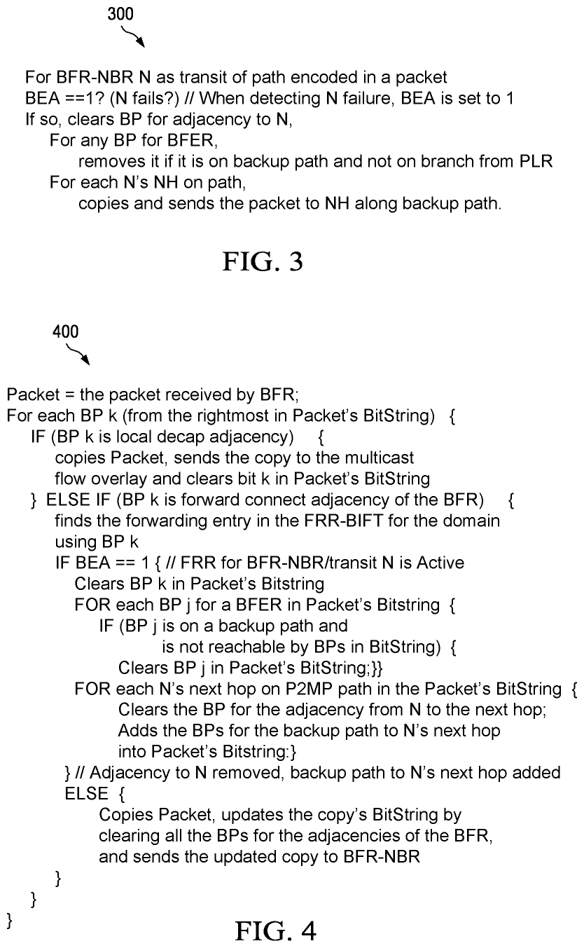

FIG. 3 is an algorithm 300 used to implement a portion of the forwarding procedure using the FRR-BIFT according to an embodiment of the disclosure. In particular, the algorithm 300 may be used to clear a bit position (a.k.a., an adjacency) in the P2MP path encoded in a packet on a backup path as described above.

For a BFR-NBR N as transit of a P2MP path encoded in a packet, the network node sets a value of BEA to 1 in a row with its column BFR-NBR=N in the FRR-BIFT built on the network node when the network node detects that N (a.k.a., the neighbor node of the network node) has failed. If N has failed (i.e., BEA=1), the network node clears the BP for the forward connected adjacency from the network node to N. For any BP for a BFER in the path encoded in the packet, the network node removes the BP for the BFER from the path if the BFER is on the backup path and not on a branch of the P2MP path encoded in the packet from the network node as a point of local repair (PLR). For each next hop of N on the path encoded in the packet, the network node removes the BP for the forward connected adjacency from N to the next hop, copies the packet and sends the copy of the packet to the next hop along the backup path from the network node to the next hop through adding the BPs of the backup path in the FRR-BIFT built on the network node into the copy of the packet.

FIG. 4 is an algorithm 400 used to implement a portion of the forwarding procedure using the FRR-BIFT according to an embodiment of the disclosure. In particular, the algorithm 400 may be used to clear a bit (a.k.a., a BP for adjacency) from a point to multipoint (P2MP) path encoded in a packet as described above.

Upon receipt of a packet, for each BP k (from the right in the BitString of the packet), if the BP k is the local decapsulation adjacency (i.e., the BP of an egress node), the network node copies the packet, sends the copy to the multicast flow overlay, and clears bit k in the BitString of the packet.

If BP k is the forward connected adjacency of the BFR (i.e., the network node), the network node finds the forwarding entry in the FRR-BIFT for the BIER-TE domain using BP k. If the neighbor node has failed (BEA=1), the network node clears the BP k in the BitString of the packet. For each BP j for a BFER in the BitString of the packet, if BP j is on a backup path and is not reachable by the BPs in the BitString from the network node, the BP j is cleared from the BitString of the packet.

For each next hop of the neighbor node on a point-to-multipoint (P2MP) path in the BitString of the packet, the network node clears the BP for the adjacency from the neighbor node to the next hop and adds the BPs for the backup path to the next hop of the neighbor node into the BitString of the packet.

Otherwise, the network node copies the packet, updates the BitString of the packet by clearing all the BPs for the adjacencies of the BFR (i.e., the network node), and sends the updated copy to the BFR-NBR.

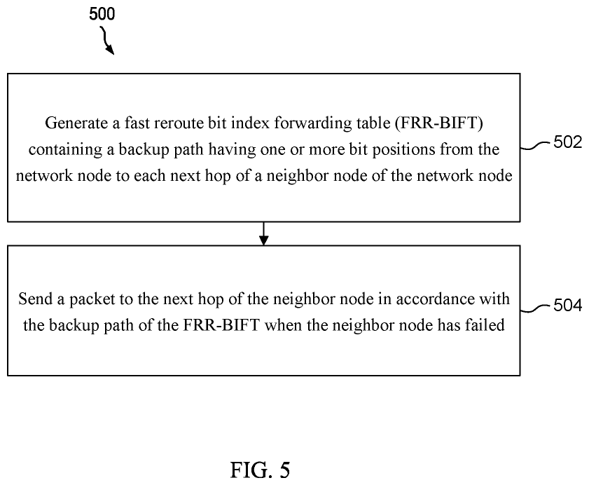

FIG. 5 is a method 500 implemented by a network node (e.g., network node 106) in the BIER-TE domain according to an embodiment of the disclosure. The method may be performed by the network node to facilitate a fast reroute procedure.

In block 502, the network node generates a fast reroute bit index forwarding table (FRR-BIFT) containing a backup path from the network node to each next hop of a neighbor node of the network node, wherein the backup path is represented by one or more bit positions for adjacencies along the backup path.

In an embodiment, the network node replaces one or more bit positions in a point to multipoint (P2MP) path in the packet with one or more bit positions of the backup path prior to sending the packet to the next hop of the neighbor node. In an embodiment, the FRR-BIFT includes a backup entry active (BEA) field, and wherein an entry in the BEA field is set to indicate whether the neighbor node is working or has failed. In an embodiment, the network node sets an entry in a backup entry active (BEA) field of the FRR-BIFT to a first value when the neighbor node is operating normally, and sets the entry in a backup entry active (BEA) field of the FRR-BIFT to a second value when the neighbor node has failed. In an embodiment, the first value is zero and the second value is one.

In block 504, the network node sends (e.g., forwards) a packet to the next hop of the neighbor node in accordance with the backup path of the FRR-BIFT when the neighbor node has failed. In an embodiment, the network node sends the packet to the next hop of the neighbor node in accordance with the one or more bit positions in the backup path of the FRR-BIFT when the neighbor node has failed. In an embodiment, the network node forwards the packet to the neighbor node in accordance with the FRR-BIFT when the neighbor node is operating normally.

In an embodiment, the network node clears the bit position of a bit-forwarding egress router (BFER) in the packet prior to forwarding the packet to the next hop when the BFER is on the backup path to the next hop but not on any path branch of the P2MP path encoded in the packet from the network node. In an embodiment, the FRR-BIFT is generated by the network node prior to receiving the packet.

In an embodiment, the network node detects a failure of the neighbor node, and wherein the FRR-BIFT is generated by the network node prior to detecting the failure. In an embodiment, forwarding the packet to the next hop of the neighbor node comprises clearing a bit position for an adjacency from the neighbor node to the next hop on a point-to-multipoint (P2MP) path in the packet and adding the one or more bit positions in the backup path from the network node to the next hop into the packet when the next hop is on the P2MP path prior to forwarding the packet to the next hop.

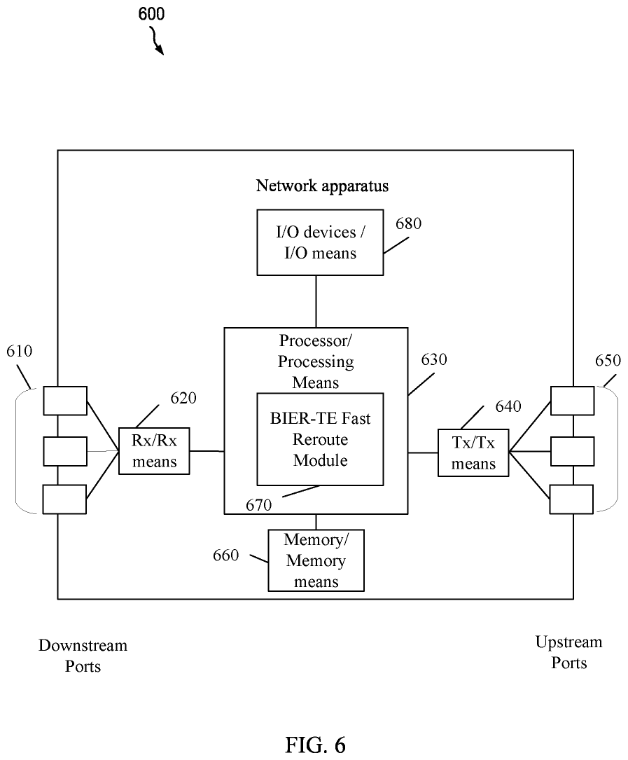

FIG. 6 is a schematic diagram of a network apparatus 600 (e.g., a network node, a destination node, a neighbor node, etc.). The network apparatus 600 is suitable for implementing the disclosed embodiments as described herein. The network apparatus 600 comprises ingress ports/ingress means 610 and receiver units (Rx)/receiving means 620 for receiving data; a processor, logic unit, or central processing unit (CPU)/processing means 630 to process the data; transmitter units (Tx)/transmitting means 640 and egress ports/egress means 650 for transmitting the data; and a memory/memory means 660 for storing the data. The network apparatus 600 may also comprise optical-to-electrical (OE) components and electrical-to-optical (EO) components coupled to the ingress ports/ingress means 610, the receiver units/receiving means 620, the transmitter units/transmitting means 640, and the egress ports/egress means 650 for egress or ingress of optical or electrical signals.

The processor/processing means 630 is implemented by hardware and software. The processor/processing means 630 may be implemented as one or more CPU chips, cores (e.g., as a multi-core processor), field-programmable gate arrays (FPGAs), application specific integrated circuits (ASICs), and digital signal processors (DSPs). The processor/processing means 630 is in communication with the ingress ports/ingress means 610, receiver units/receiving means 620, transmitter units/transmitting means 640, egress ports/egress means 650, and memory/memory means 660. The processor/processing means 630 comprises a BIER-TE fast reroute module 670. The BIER-TE fast reroute module 670 is able to implement the methods disclosed herein. The inclusion of the BIER-TE fast reroute module 670 therefore provides a substantial improvement to the functionality of the network apparatus 600 and effects a transformation of the network apparatus 600 to a different state. Alternatively, the BIER-TE fast reroute module 670 is implemented as instructions stored in the memory/memory means 660 and executed by the processor/processing means 630.

The network apparatus 600 may also include input and/or output (I/O) devices or I/O means 680 for communicating data to and from a user. The I/O devices or I/O means 680 may include output devices such as a display for displaying video data, speakers for outputting audio data, etc. The I/O devices or I/O means 680 may also include input devices, such as a keyboard, mouse, trackball, etc., and/or corresponding interfaces for interacting with such output devices.

The memory/memory means 660 comprises one or more disks, tape drives, and solid-state drives and may be used as an over-flow data storage device, to store programs when such programs are selected for execution, and to store instructions and data that are read during program execution. The memory/memory means 660 may be volatile and/or non-volatile and may be read-only memory (ROM), random access memory (RAM), ternary content-addressable memory (TCAM), and/or static random-access memory (SRAM).

While several embodiments have been provided in the present disclosure, it may be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, components, techniques, or methods without departing from the scope of the present disclosure. Other examples of changes, substitutions, and alterations are ascertainable by one skilled in the art and may be made without departing from the spirit and scope disclosed herein.

What is claimed is:

1. A method implemented by a network node in a Bit Index Explicit Replication Traffic Engineering (BIER-TE) domain, comprising:
generating a fast reroute bit index forwarding table (FRR-BIFT) containing a backup path from the network node to each next hop of a neighbor node of the network node, wherein the backup path is represented by one or more bit positions for adjacencies along the backup path; and
sending a packet to the next hop of the neighbor node in accordance with the backup path of the FRR-BIFT when the neighbor node has failed.

2. The method of claim 1, further comprising sending the packet to the neighbor node in accordance with the FRR-BIFT when the neighbor node is operating normally.

3. The method of claim 1, further comprising replacing one or more bit positions in a point to multipoint (P2MP) path in the packet with the one or more bit positions of the backup path prior to sending the packet to the next hop of the neighbor node.

4. The method of claim 1, further comprising setting an entry in a backup entry active (BEA) field of the FRR-BIFT to a first value when the neighbor node is operating normally, and setting the entry in a backup entry active (BEA) field of the FRR-BIFT to a second value when the neighbor node has failed.

5. The method of claim 4, wherein the first value is zero and the second value is one.

6. The method of claim 1, further comprising clearing a bit position of a bit-forwarding egress router (BFER) in the packet prior to sending the packet to the next hop when the BFER is on the backup path to the next hop but not on any path branch of a point-to-multipoint (P2MP) path in the packet from the network node.

7. The method of claim 1, wherein the FRR-BIFT is generated by the network node prior to receiving the packet.

8. The method of claim 1, further comprising detecting a failure of the neighbor node, and wherein the FRR-BIFT is generated by the network node prior to detecting the failure.

9. The method of claim 1, wherein sending the packet to the next hop of the neighbor node comprises clearing a bit position for an adjacency from the neighbor node to the next hop on a point-to-multipoint (P2MP) path in the packet and adding the one or more bit positions in the backup path from the network node to the next hop into the packet when the next hop is on the P2MP path prior to sending the packet to the next hop.

10. A network node in a Bit Index Explicit Replication Traffic Engineering (BIER-TE) domain, comprising:
a memory storing instructions; and
one or more processors coupled to the memory, wherein the one or more processors are configured to execute the instructions to cause the network node to:
generate a fast reroute bit index forwarding table (FRR-BIFT) containing a backup path from the network node to each next hop of a neighbor node of the network node, wherein the backup path is represented by one or more bit positions for adjacencies along the backup path; and
send a packet to the next hop of the neighbor node in accordance with the backup path of the FRR-BIFT when the neighbor node has failed.

11. The network node of claim 10, wherein the one or more processors are configured to send the packet to the neighbor node in accordance with the FRR-BIFT when the neighbor node is operating normally.

12. The network node of claim 10, wherein the one or more processors are configured to replace one or more bit positions in a point to multipoint (P2MP) path in the packet with the one or more bit positions of the backup path prior to the packet being sent to the next hop of the neighbor node.

13. The network node of claim 10, wherein the one or more processors are configured to set an entry in a backup entry active (BEA) field of the FRR-BIFT to a first value when the neighbor node is operating normally, and to set the entry in a backup entry active (BEA) field of the FRR-BIFT to a second value when the neighbor node has failed.

14. The network node of claim 13, wherein the first value is zero and the second value is one.

15. The network node of claim 10, further comprising clearing a bit position of a bit-forwarding egress router (BFER) in the packet prior to sending the packet to the next hop when the BFER is on the backup path to the next hop but not on any path branch of a point-to-multipoint (P2MP) path in the packet from the network node.

16. The network node of claim 10, wherein the FRR-BIFT is generated by the network node prior to receiving the packet.

17. The network node of claim 10, wherein the one or more processors are configured to detect a failure of the neighbor node, and wherein the FRR-BIFT is generated by the network node prior to detecting the failure.

18. The network node of claim 10, wherein sending the packet to the next hop of the neighbor node comprises clearing a bit position for an adjacency from the neighbor node to the next hop on a point-to-multipoint (P2MP) path in the packet and adding the one or more bit positions in the backup path from the network node to the next hop into the packet when the next hop is on the P2MP path prior to sending the packet to the next hop.

19. A method implemented by a network node in a Bit Index Explicit Replication Traffic Engineering (BIER-TE) domain, comprising:
generating a fast reroute bit index forwarding table (FRR-BIFT) containing a backup path from the network node to each next hop of a neighbor node of the network node, wherein the backup path is represented by one or more bit positions for adjacencies along the backup path;
replacing one or more bit positions in a point to multipoint (P2MP) path in the packet with the one or more bit positions of the backup path;
sending a packet to the next hop of the neighbor node in accordance with the backup path of the FRR-BIFT when the neighbor node has failed; and
sending the packet to the neighbor node in accordance with the FRR-BIFT when the neighbor node is operating normally.

20. The method of claim 19, further comprising setting an entry in a backup entry active (BEA) field of the FRR-BIFT to a first value when the neighbor node is operating normally, and setting the entry in a backup entry active (BEA) field of the FRR-BIFT to a second value when the neighbor node has failed.
